(19) United States
(12) Patent Application Publication
(10) Pub. No.: US 2008/0239146 A1
(43) Pub. Date: Oct. 2, 2008

(54) VIDEO SIGNAL INTERPOLATION APPARATUS AND METHOD THEREOF

(75) Inventor: Toshiyuki NAMIOKA, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 12/025,284

(22) Filed: Feb. 4, 2008

(30) Foreign Application Priority Data
Mar. 30, 2007 (JP) 2007-090361

(51) Int. Cl. H04N 7/01

(52) U.S. Cl. 348/452; 348/E07.003

(57) ABSTRACT

According to one embodiment, a video signal interpolation apparatus has: a correlation calculating unit calculating correlation calculation values by correlating each of a plurality of peripheral pixels with another plurality of peripheral pixels existing in a periphery of an object interpolation pixel; a sub-pixel estimation unit estimating a position of sub-pixel having an equivalent luminance value to that of the respective peripheral pixel based on the plurality of correlation calculation values calculated for each of the plurality of peripheral pixels; and a weighted average calculating unit calculating a weighted average of a pixel value in accordance with distances between each of the sub-pixel and the object interpolation pixel to determine a pixel value of the object interpolation pixel.

### CROSS-REFERENCE TO RELATED APPLICATIONS

This application is based upon and claims the benefit of priority from Japanese Patent Application No. 2007-90361, filed Mar. 30, 2007, the entire contents of which are incorporated herein by reference.

### BACKGROUND

1. Field

One embodiment of the invention relates to a video signal interpolation apparatus and a method thereof.

2. Description of the Related Art

A conventional document (Japanese Patent Application Laid-open No. Hei 4-364685) discloses an example of a video signal interpolation apparatus used in a video display apparatus. This video signal interpolation apparatus applies a vertical interpolation processing which performs interpolation using two pixels located above and below in the vertical direction of an object interpolation pixel and a diagonal interpolation processing which performs interpolation using two pixels located above and below in the diagonal direction of the object interpolation pixel. In the diagonal interpolation processing, a correlation between an image block located diagonally above the object interpolation pixel and an image block located diagonally below the object interpolation pixel is detected to thereby conduct interpolation using two pixels of the image blocks preferably correlating each other.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing a video signal interpolation apparatus according to an embodiment of the invention;

FIG. 2 is an exemplary schematic diagram to show images to be inputted into the video signal interpolation apparatus in the embodiment;

FIG. 3 is a first exemplary schematic diagram to explain an interpolation processing by the video signal interpolation apparatus in the embodiment;

FIG. 4 is a second exemplary schematic diagram to explain the interpolation processing by the video signal interpolation apparatus in the embodiment;

FIG. 5 is a third exemplary schematic diagram to explain the interpolation processing by the video signal interpolation apparatus in the embodiment;

FIG. 6 is a fourth exemplary schematic diagram to explain the interpolation processing by the video signal interpolation apparatus in the embodiment;

FIG. 7 is a fifth exemplary schematic diagram to explain the interpolation processing by the video signal interpolation apparatus in the embodiment; and

FIG. 8 is an exemplary block diagram showing an example of a television apparatus equipped with the video signal interpolation apparatus in the embodiment.

### DETAILED DESCRIPTION

Various embodiments according to the invention will be described hereinafter with reference to the accompanying drawings. In general, according to one embodiment of the invention, a video signal interpolation apparatus has: a correlation calculating unit calculating correlation calculation values by correlating each of a plurality of peripheral pixels with another plurality of peripheral pixels existing in a periphery of an object interpolation pixel; a sub-pixel estimation unit estimating a position of sub-pixel having an equivalent luminance value to that of the respective peripheral pixel based on the plurality of correlation calculation values calculated for each of the plurality of peripheral pixels; and a weighted average calculating unit calculating a weighted average of a pixel value in accordance with distances between each of the sub-pixel and the object interpolation pixel to determine a pixel value of the object interpolation pixel.

A video signal interpolation apparatus has: a correlation calculating unit calculating correlation calculation values by correlating each of a plurality of peripheral pixels with another plurality of peripheral pixels existing in a periphery of an object interpolation pixel; a sub-pixel estimation unit calculating a position of sub-pixel having an equivalent luminance value to that of the respective peripheral pixel based on the plurality of correlation calculation values calculated for each of the plurality of peripheral pixels; a weighted average calculating unit calculating a weighted average of a pixel value in accordance with distances between each of the sub-pixel and the object interpolation pixel to determine a pixel value of the object interpolation pixel; and a display displaying a video being calculated by the weighted average calculating unit.

A video signal interpolation method is a method calculating correlation calculation values by correlating each of a plurality of peripheral pixels with another plurality of peripheral pixels existing in a periphery of an object interpolation pixel, calculating a position of sub-pixel having an equivalent luminance value to that of the respective peripheral pixel based on the plurality of correlation calculation values calculated for each of the plurality of peripheral pixels and calculating a weighted average of a pixel value in accordance with distances between each of the sub-pixel and the object interpolation pixel to determine a pixel value of the object interpolation pixel.

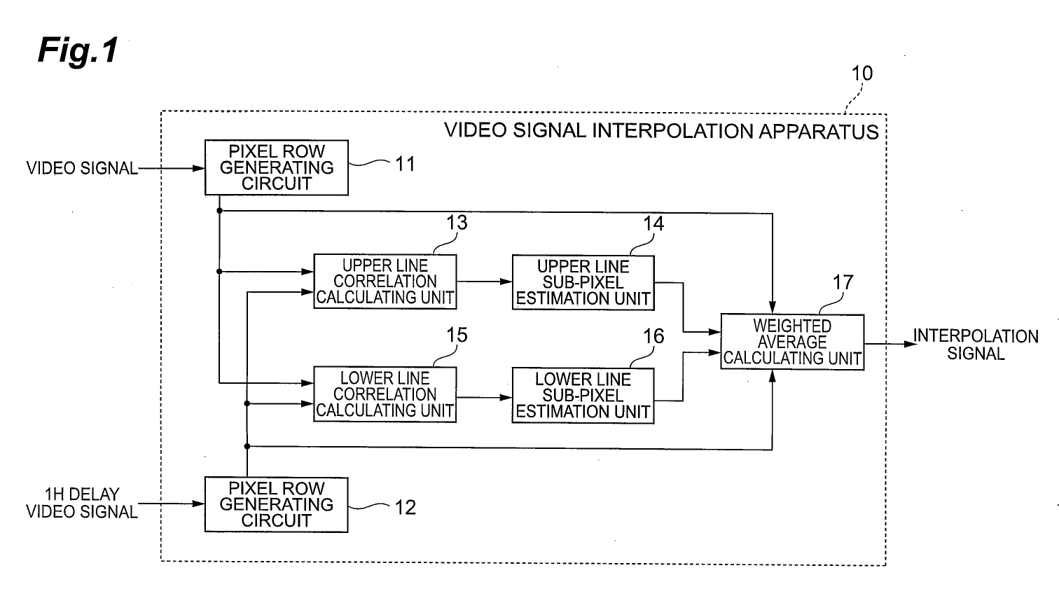

FIG. 1 is a block diagram showing a video signal interpolation apparatus 10 according to the embodiment. The video signal interpolation apparatus 10 has: two pixel row generating circuits 11 and 12; an upper line correlation calculating unit 13; an upper line sub-pixel estimation unit 14; a lower line correlation calculating unit 15; a lower line sub-pixel estimation unit 16; and a weighted average calculating unit 17.

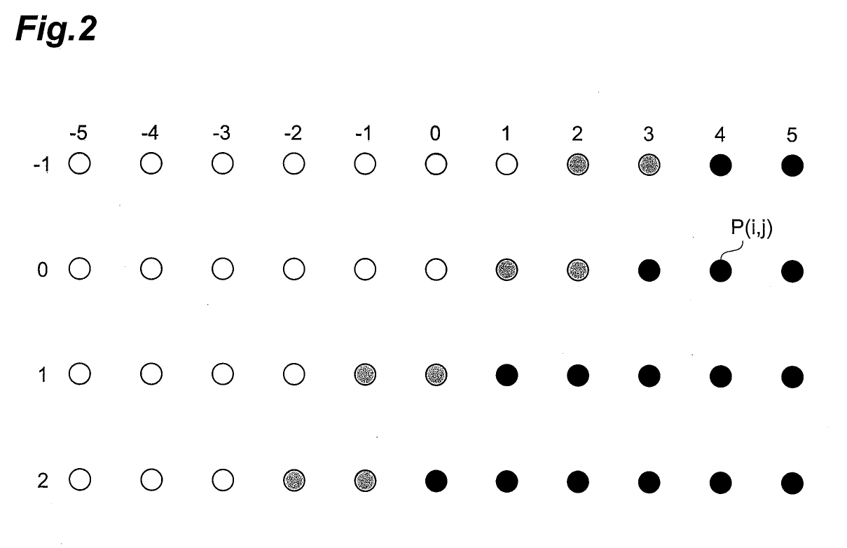

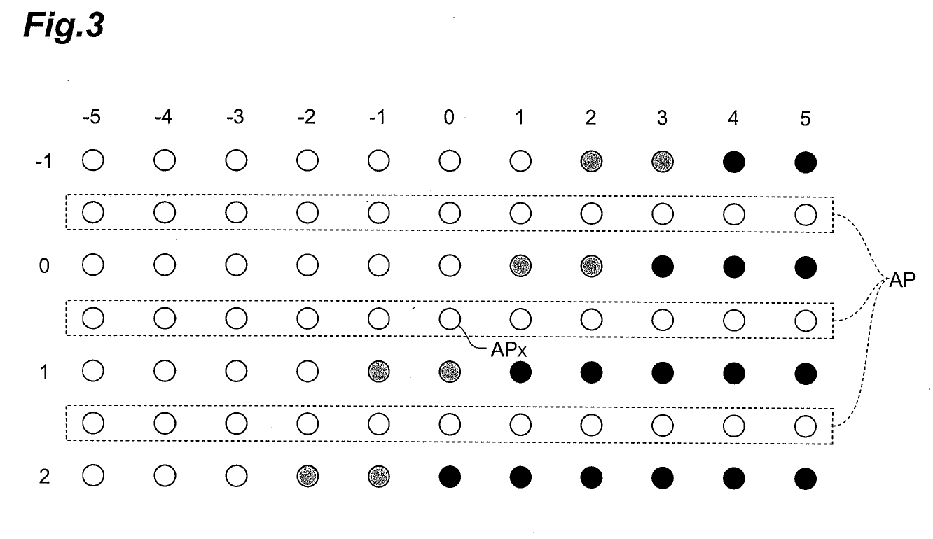

FIG. 2 shows images to be inputted into the video signal interpolation apparatus 10. The video signal interpolation apparatus 10 inserts, between horizontal pixel rows, new horizontal pixel rows AP as shown in FIG. 3. Hereinafter, processings conducted by each components of the video signal interpolation apparatus 10 will be explained by showing a situation where an object interpolation pixel APx is generated by the video signal interpolation apparatus 10, as an example. Note that in the drawings hereinafter, a lateral direction position i is indicated on an upper side of a pixel group and a vertical direction position j is indicated on a left side of the pixel group. Further, a pixel having the lateral direction position i and the vertical direction position j is defined as P (i, j).

The pixel row generating circuit 11 located on an upper side takes in a video signal to generate pixel rows having plural luminance values. The pixel row generating circuit 12 located on a lower side takes in an 1H delay video signal to generate pixel rows having plural luminance values. The pixel rows generated by the pixel row generating circuit 12 on the lower side are delayed for one horizontal period from the pixel rows generated by the pixel row generating circuit 11 on the upper side.

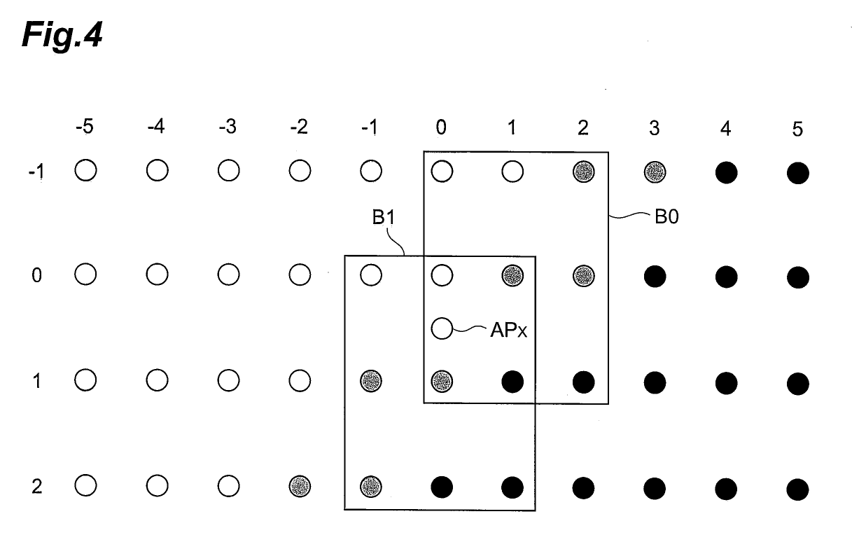

The upper line correlation calculating unit 13 calculates correlation calculation values by correlating each of a plurality of peripheral pixels with another plurality of peripheral pixels existing in a periphery of the object interpolation pixel APx. Details will be explained more specifically with reference to FIG. 4. The upper line correlation calculating unit 13 generates a block B0 of 3×3 pixels in which one pixel in a horizontal pixel row positioned one line above the object interpolation pixel APx (j=0) is a center pixel thereof. At the same time, the upper line correlation calculating unit 13 generates a block B1 of 3×3 pixels in which one pixel in a horizontal pixel row positioned one line below the object interpolation pixel APx (j=1) is a center pixel thereof. Subsequently, the upper line correlation calculating unit 13 calculates the correlation calculation values such as a total sum of difference absolute value and a total sum of difference square value between the block B0 and the block B1.

More specifically, the upper line correlation calculating unit 13 generates the block B0 in which each pixels included in the horizontal pixel row comprising P (−5, 0) through P (5, 0) positioned one line above the APx is a center pixel thereof and at the same time, it generates the block B1 in which each pixels included in the horizontal pixel row comprising P (−5, 1) through P (5, 1) positioned one line below the APx is a center pixel thereof. Subsequently, the upper line correlation calculating unit 13 calculates the correlation calculation values for every combination of the block B0 and the block B1. The upper line correlation calculating unit 13 outputs the correlation calculation values calculated for each pixels in the horizontal pixel row positioned one line above the APx. Note that when a pattern of the block B0 is similar to that of the block B1 as shown in FIG. 4, the block B0 and the block B1 are in a good correlation with each other.

Note that when calculating the total sum of difference absolute value as the correlation calculation value, the upper line correlation calculating unit 13 calculates a difference of luminance values between two pixels corresponding each other in the block B0 and the block B1, then add the absolute value of all the differences thereto. Further, when calculating the total sum of difference square value as the correlation calculation value, the upper line correlation calculating unit 13 calculates a difference of luminance values between two pixels corresponding each other in the block B0 and the block B1, then add the square value of all the differences thereto. The correlation calculation value calculated in such a manner is an index value indicating a degree of correlation between the block B0 and the block B1. The correlation calculation value becomes smaller as the degree of correlation between the block B0 and the block B1 becomes large, while it becomes larger as the degree of correlation between the block B0 and the block B1 becomes small.

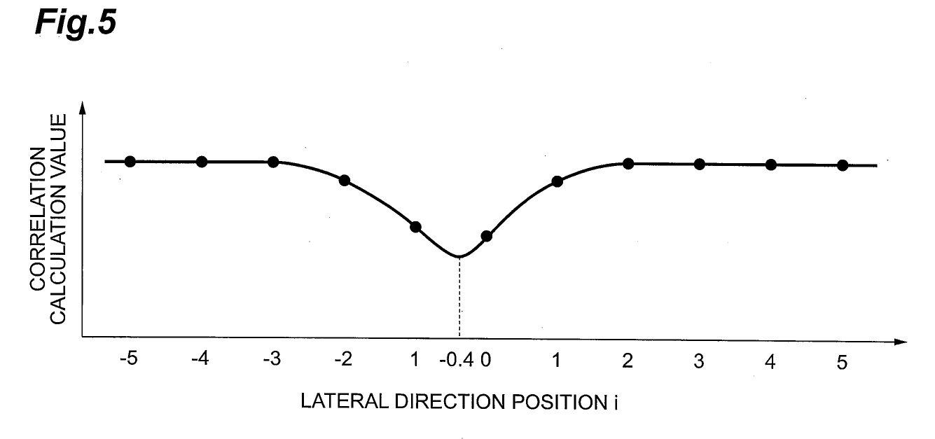

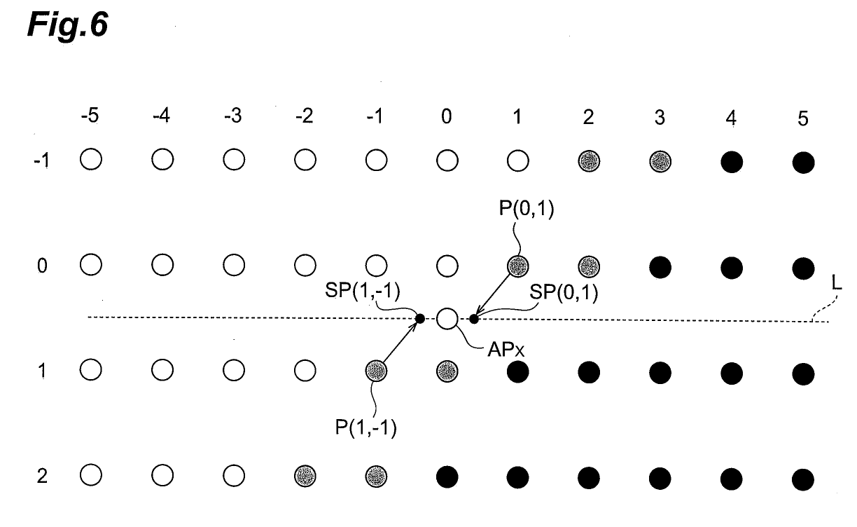

The upper line sub-pixel estimation unit 14 estimates a direction and a position of sub-pixel having an equivalent luminance value to that of each peripheral pixel based on the correlation calculation values calculated for the respective peripheral pixel located one line above the APx. An estimating procedure of sub-pixels by the upper line sub-pixel estimation unit 14 will be explained more specifically with reference to FIG. 5 and FIG. 6.

FIG. 5 shows correlation calculation values calculated for one specific pixel in a horizontal pixel row comprising P (−5, 0) through P (5, 0) located one line above the APx. In FIG. 5, a horizontal axis indicates a lateral direction position i of each pixels P (−5, 1) through P (5, 1) located one line below the APx, while a vertical axis indicates correlation calculation values between the block B0 in which one specific pixel is a center pixel thereof and the block B1 in which each pixels located one line below the APx is a center pixel thereof. The upper line sub-pixel estimation unit 14 joins plural dots indicating the correlation calculation values using an approximated curve to interpolate between the plural dots. Accordingly, the upper line sub-pixel estimation unit 14 calculates the lateral direction position i where the correlation calculation values become the smallest, here, which is −0.4.

The upper line sub-pixel estimation unit 14 calculates the lateral direction position i where the correlation calculation values calculated for every pixels P (−5, 0) through P (5, 0) located one line above the APx become the smallest. Here, the lateral direction position i indicates a direction and a position of sub-pixel having a same luminance value as that of each peripheral pixel. In other words, as shown in FIG. 6, the lateral direction position i is equivalent to the direction (arrow) which is pointed to the sub-pixel having the same luminance value as that of each peripheral pixel, and it is also equivalent to the position of sub-pixel having the same luminance value as that of each peripheral pixel on a horizontal line L where the object interpolation pixel APx is lined thereon. The upper line sub-pixel estimation unit 14 outputs the lateral direction position i calculated for every pixels positioned one line above the APx.

The lower line correlation calculating unit 15 performs a similar processing to that of the above-described upper line correlation calculating unit 13. In other words, the lower line correlation calculating unit 15 calculates the correlation calculation values for every combination of the block B0 and the block B1. Accordingly, the lower line correlation calculating unit 15 outputs the correlation calculation values calculated for each pixels P (−5, 1) through P (5, 1) located one line below the APx.

The lower line sub-pixel estimation unit 16 performs a similar processing to that of the upper line sub-pixel estimation unit 14. In other words, the lower line sub-pixel estimation unit 16 calculates the lateral direction position i of each pixels P (−5, 0) through P (5, 0) located one line above the APx where the correlation calculation values calculated for every pixels P (−5, 1) through P (5, 1) located one line below the APx become the smallest. The lower line sub-pixel estimation unit 16 then estimates the direction and the position of sub-pixel having the same luminance value as that of each pixels P (−5, 1) through P (5, 1) located one line below the APx. Accordingly, the lower line sub-pixel estimation unit 16 outputs the lateral direction position i calculated for every pixels positioned one line below the APx.

The weighted average calculating unit 17 selects two sub-pixels being in positions sandwiching the object interpolation pixel APx and also being in the vicinity thereof among plural sub-pixels estimated by the upper line sub-pixel estimation unit 14 and the lower line sub-pixel estimation unit 16. Especially, since the video signal interpolation apparatus 10 of the embodiment conducts the diagonal interpolation, the weighted average calculating unit 17 selects sub-pixels having equivalent luminance values to those of peripheral pixels located diagonally above and below the APx, respectively. Accordingly, the weighted average calculating unit 17 calculates the weighted average of luminance values of the two sub-pixels in accordance with distances between each of the sub-pixel and the object interpolation pixel APx to determine a luminance value of the object interpolation pixel APx.

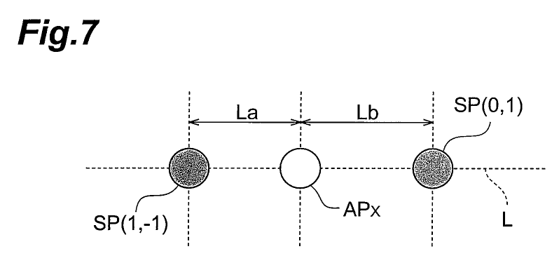

As shown in FIG. 7, when a distance from a sub-pixel SP (1, −1) to the object interpolation pixel APx is La and a distance from a sub-pixel SP (0, 1) to the object interpolation pixel APx is Lb, the weighted average calculating unit 17 calculates the luminance value of the object interpolation pixel APx by combining the luminance value of sub-pixel SP (1, −1) with a value Lb/(La+Lb) multiplied thereto and the luminance value of sub-pixel SP (0, 1) with a value La/(La+Lb) multiplied thereto. The weighted average calculating unit 17 outputs the interpolated video signal.

According to the video signal interpolation apparatus 10 in the embodiment, it is possible to interpolate the object interpolation pixel APx with high accuracy since the luminance value of the object interpolation pixel APx is determined using plural sub-pixels having maximum correlation values calculated for peripheral pixels existing in a periphery of the object interpolation pixel APx. By interpolating the object interpolation pixel APx with high accuracy as described above, it is possible to display a video with a sufficiently high image quality without any lack of interpolation accuracy of a video even in a flat panel display with large screen with high resolution.

Note that in the above-described embodiment, the luminance values of two pixels existing in the periphery of the object interpolation pixel APx are used to interpolate the luminance value of the interpolation pixel APx, however, it is possible to use the luminance values of 3 or more pixels existing in the periphery of the object interpolation pixel APx. Further, in the above-described embodiment, the luminance values of pixels located on an upper horizontal line and a lower horizontal line, respectively are used to interpolate the luminance value of the object interpolation pixel APx, however, it is possible to use the luminance values of two or more pixels on the upper horizontal line and further it is also possible to use the luminance values of two or more pixels on the lower horizontal line.

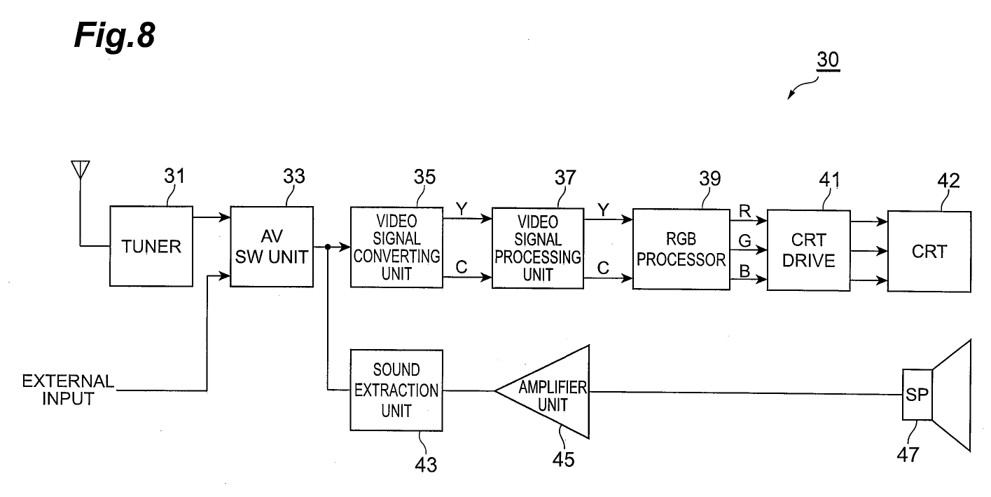

Subsequently, an example of a television apparatus 30 (video display apparatus) provided with the above-described video signal interpolation apparatus 10 will be explained with reference to FIG. 8. FIG. 8 is a block diagram showing an example of a television apparatus provided with a video signal interpolation apparatus 10 according to the embodiment.

The television apparatus 30 has: a tuner 31 demodulating a broadcast signal supplied from an antenna element to output a video sound signal; an AV switch (SW) unit 33 performing a switching to an external input upon receiving the video sound signal; and a video signal converting unit 35 performing a predetermined video signal processing to the supplied video signal to thereby output it after converting to a Y signal and a color difference signal. The television apparatus is further provided with a sound extraction unit 43 separating a sound signal from the video sound signal and an amplifier unit 45 appropriately amplifying the sound signal outputted from the sound extraction unit 43 to thereby supply it to a speaker 47.

Here, the above-described video signal interpolation apparatus 10 is applied to a video signal processing unit 37 to which the video signal is supplied from the video signal converting unit 35. A noninterlaced video signal is separated into R, G and B signals by an RGB processor 39, which are then appropriately power amplified by a CRT drive 41 to be displayed as a video by a CRT 42.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video signal interpolation apparatus comprising:
a correlation calculating unit calculating correlation calculation values by correlating each of a plurality of peripheral pixels with another plurality of peripheral pixels existing in a periphery of an object interpolation pixel;
a sub-pixel estimation unit estimating a position of sub-pixel having an equivalent luminance value to that of the respective peripheral pixel based on the plurality of correlation calculation values calculated for each of the plurality of peripheral pixels; and
a weighted average calculating unit calculating a weighted average of a pixel value in accordance with a distance between each of the sub-pixel and the object interpolation pixel to determine a pixel value of the object interpolation pixel.

2. The video signal interpolation apparatus according to claim 1,
wherein said correlation calculating unit calculates correlation calculation values between each of the peripheral pixels lined above the object interpolation pixel and each of the peripheral pixels lined below the object interpolation pixel.

3. The video signal interpolation apparatus according to claim 2,
wherein said sub-pixel estimation unit calculates an extremal value of the correlation calculation values determined by correlating each of the peripheral pixels lined above the object interpolation pixel with the peripheral pixels lined below the object interpolation pixel to thereby estimate a position corresponding to the extremal value of the correlation calculation values as a position of the sub-pixel.

4. The video signal interpolation apparatus according to claim 2,
wherein said sub-pixel estimation unit calculates an extremal value of the correlation calculation values determined by correlating each of the peripheral pixels lined below the object interpolation pixel with the peripheral pixels lined above the object interpolation pixel to thereby estimate a position corresponding to the extremal value of the correlation calculation values as a position of the sub-pixel.

5. The video signal interpolation apparatus according to claim 1,
wherein said sub-pixel estimation unit estimates a position of each of the sub-pixel located on a horizontal line where the object interpolation pixel is lined thereon.

6. The video signal interpolation apparatus according to claim 1,
wherein said weighted average calculating unit calculates a weighted average of the pixel values on basis of positions of sub-pixels having equivalent luminance values to those of peripheral pixels being located diagonally above/below the object interpolation pixel, respectively.

7. The video signal interpolation apparatus according to claim 1,
wherein said weighted average calculating unit selects positions of two or more sub-pixels being in the vicinity of the object interpolation pixel among the plurality of positions of sub-pixels estimated by said sub-pixel estimation unit to thereby calculate the weighted average of the pixel values based on the selected positions of sub-pixels.

8. A video signal interpolation apparatus comprising:
a correlation calculating unit calculating correlation calculation values by correlating each of a plurality of peripheral pixels with another plurality of peripheral pixels existing in a periphery of an object interpolation pixel;
a sub-pixel estimation unit estimating a position of sub-pixel having an equivalent luminance value to that of the respective peripheral pixel based on the plurality of correlation calculation values calculated for each of the plurality of peripheral pixels;
a weighted average calculating unit calculating a weighted average of a pixel value in accordance with a distance between each of the sub-pixel and the object interpolation pixel to determine a pixel value of the object interpolation pixel; and
a display displaying a video being calculated by said weighted average calculating unit.

9. A video signal interpolation method comprising:
calculating correlation calculation values by correlating each of a plurality of peripheral pixels with another plurality of peripheral pixels existing in a periphery of an object interpolation pixel;
estimating a position of sub-pixel having an equivalent luminance value to that of the respective peripheral pixel based on the plurality of correlation calculation values calculated for each of the plurality of peripheral pixels; and
calculating a weighted average of a pixel value in accordance with a distance between each of the sub-pixel and the object interpolation pixel to determine a pixel value of the object interpolation pixel.
